(19) United States
(12) Patent Application Publication
(10) Pub. No.: US 2025/0345919 A1
(43) Pub. Date: Nov. 13, 2025

(54) QUICK-CHANGE ASSEMBLY FOR REACTION ARM POWER TOOL

(71) Applicant: MILWAUKEE ELECTRIC TOOL CORPORATION, Brookfield, WI (US)

(72) Inventor: Mitchell Gibson, New Berlin, WI (US)

(21) Appl. No.: 19/201,531

(22) Filed: May 7, 2025

Related U.S. Application Data
(60) Provisional application No. 63/688,141, filed on Aug. 28, 2024.
(60) Provisional application No. 63/756,505, filed on Feb. 10, 2025.

(30) Foreign Application Priority Data
May 7, 2024 (CN) 2024209971146

(51) Int. Cl. B25F 5/02

(52) U.S. Cl. CPC B25F 5/028

(57) ABSTRACT

A reaction arm accessory for a power tool may include a body having a distal end configured to engage a fixed structure and an attachment end defining a splined connection configured to engage a splined interface of the power tool, the splined interface including a plurality of spline teeth defining gaps between adjacent spline teeth. The accessory may include a quick-change removal assembly supported in the body adjacent the splined connection and configured to selectively secure the reaction arm accessory to the splined interface of the tool. The quick-change removal assembly may include a collar rotatable between a locked position and an unlocked position, the collar including a plurality of locking protrusions and a spring surrounding the collar and configured to urge the collar towards the locked position.

### CROSS-REFERENCE TO RELATED APPLICATIONS

This application claims priority to Chinese Utility Model application No. 2024209971146.X, filed May 7, 2024, to U.S. Provisional Patent Application No. 63/688,141, filed Aug. 28, 2024, and to U.S. Provisional Patent Application No. 63/756,505, filed Feb. 10, 2025, the entire contents of all of which are incorporated herein by reference.

### FIELD

The present disclosure relates to reaction arm power tools, and more specifically to accessories for reaction arm power tools.

### BACKGROUND

Reaction arm tools are a form of rotary power tool used to drive fasteners, such as nuts and bolts, particularly in high torque applications. Reaction arm tools include a reaction arm fixed to a housing of the tool and engageable with a fixed structure (e.g., an adjacent fastener in a bolt pattern). When applying torque to a fastener, the reaction arm transmits the reaction torque to the fixed structure rather than to a user holding the tool.

### SUMMARY

In some aspects, the techniques described herein relate to a reaction arm accessory for a power tool, the reaction arm accessory including: a body having a distal end configured to engage a fixed structure and an attachment end defining a splined connection configured to engage a splined interface of the power tool, the splined interface including a plurality of spline teeth defining gaps between adjacent spline teeth; and a quick-change removal assembly supported in the body adjacent the splined connection and configured to selectively secure the reaction arm accessory to the splined interface of the tool, the quick-change removal assembly including a collar rotatable between a locked position and an unlocked position, the collar including a plurality of locking protrusions, and a spring surrounding the collar and configured to urge the collar towards the locked position, wherein each of the plurality of locking protrusions is configured to engage a corresponding one of the plurality of spline teeth when the collar is in the locked position to axially retain the reaction arm accessory on the power tool, and wherein each of the plurality of locking protrusions is aligned with a respective one of the gaps when the collar is in the unlocked position to allow the reaction arm accessory to be axially removed from the power tool.

In some aspects, the techniques described herein relate to a reaction arm accessory, wherein each of the plurality of locking protrusions has a trapezoidal shape.

In some aspects, the techniques described herein relate to a reaction arm accessory, wherein the spring is a torsion spring.

In some aspects, the techniques described herein relate to a reaction arm accessory, wherein the spring includes a first arm coupled to the body and a second arm coupled to the collar.

In some aspects, the techniques described herein relate to a reaction arm accessory, wherein the attachment end of the body includes a lip surrounding the splined interface.

In some aspects, the techniques described herein relate to a reaction arm accessory, wherein the collar includes an actuator extending radially outwardly from the collar.

In some aspects, the techniques described herein relate to a reaction arm accessory, wherein the lip includes a slot, and wherein the actuator is received within the slot.

In some aspects, the techniques described herein relate to a reaction arm accessory, wherein the actuator abuts a first end of the slot when the collar is in the locked position and abuts a second end of the slot opposite the first end when the collar is in the unlocked position.

In some aspects, the techniques described herein relate to a reaction arm accessory, wherein the actuator includes a textured surface to facilitate manipulation of the actuator.

In some aspects, the techniques described herein relate to a reaction arm accessory, further including a ring received within a circumferential groove formed on an inner side of the lip.

In some aspects, the techniques described herein relate to a reaction arm accessory, wherein the collar defines an outer diameter, and wherein the ring defines an inner diameter smaller than the outer diameter such that the ring axially retains the collar while allowing rotational movement of the collar.

In some aspects, the techniques described herein relate to a reaction arm accessory, wherein the ring is concentric with the collar.

In some aspects, the techniques described herein relate to a reaction arm accessory for a power tool, the reaction arm accessory including: a body having a distal end configured to engage a fixed structure and an attachment end configured to receive and engage an attachment interface of the power tool such that the body is rotationally fixed relative to the attachment interface of the power tool; and a quick-change removal assembly configured to selectively axially secure the body to the attachment interface of the tool, the quick-change removal assembly including a collar rotatable between a locked position and an unlocked position, the collar including a locking protrusion configured to engage a portion of the attachment interface to prevent removal of the reaction arm accessory from the power tool along an axis when the collar is in the locked position, and wherein the locking protrusion is configured to move out of engagement with the portion of the attachment interface when the collar is moved to the unlocked position to permit removal of the reaction arm accessory from the power tool along the axis, an actuator extending radially outwardly from the collar, and a torsion spring surrounding the collar and configured to urge the collar towards the locked position.

In some aspects, the techniques described herein relate to a reaction arm accessory, the locking protrusion has a trapezoidal shape.

In some aspects, the techniques described herein relate to a reaction arm accessory, wherein the spring includes a first arm coupled to the body and a second arm coupled to the collar.

In some aspects, the techniques described herein relate to a reaction arm accessory, wherein the actuator includes a textured surface to facilitate manipulation of the actuator.

In some aspects, the techniques described herein relate to a reaction arm accessory, further including a ring, wherein the collar defines an outer diameter, wherein the ring defines an inner diameter smaller than the outer diameter such that the ring axially retains the collar while allowing rotational movement of the collar, and wherein the ring is concentric with the collar.

In some aspects, the techniques described herein relate to a reaction arm accessory for a power tool, the reaction arm accessory including: a body having a distal end configured to engage a fixed structure and an attachment end defining a splined connection configured to engage a splined interface of the power tool; and a quick-change removal assembly supported in the body adjacent the splined connection and configured to selectively secure the reaction arm accessory to the splined interface of the tool, the quick-change removal assembly including a pin slidably supported in the body and movable between a locked position and an unlocked position, the pin having a shoulder, and a spring configured to urge the pin towards the locked position, wherein the shoulder is configured to engage a circumferential groove formed in the splined interface of the power tool when the pin is in the locked position to axially retain the reaction arm accessory on the power tool.

In some aspects, the techniques described herein relate to a reaction arm accessory, wherein the reaction arm accessory is removable from the power tool along an axis when the pin is in the locked position, and wherein the pin is movable between the locked position and the unlocked position in a direction perpendicular to the axis.

In some aspects, the techniques described herein relate to a reaction arm accessory for a power tool, the reaction arm accessory including: a body having a distal end configured to engage a fixed structure and an attachment end defining a splined connection configured to engage a splined interface of the power tool; and a quick-change removal assembly supported in the body adjacent the splined connection and configured to selectively secure the reaction arm accessory to the splined interface of the tool, the quick-change removal assembly including a detenting switch rotatably supported in the body and movable between a locked position and an unlocked position, the detenting switch having a cam surface, a torsional spring having a first end coupled to the body and a second end coupled to the detenting switch, the torsional spring configured to urge the detenting switch towards a locked position, a securing pin configured to secure the detenting switch within the body, and a detenting pin translationally supported within the body, wherein the cam surface of the detenting switch is configured translate the detenting pin between a first position where the detenting pin is within the splined connection when the detenting switch is in the locked position and a second position where the detenting pin is out of the splined connection when the detenting switch is in the unlocked position.

In some aspects, the techniques described herein relate to a reaction arm accessory, wherein an insertion axis extends centrally through the splined connection and is parallel with a drive axis of the power tool when the reaction arm accessory is coupled to the tool, the body includes a first aperture configured to receive the detenting switch and the torsional spring, and the first aperture defines a first receiving axis that is parallel to the insertion axis defined by the splined connection.

In some aspects, the techniques described herein relate to a reaction arm accessory, wherein the body includes a second aperture that is in communication with the first aperture, the second aperture defines a second receiving axis that is orthogonal to the first receiving axis, and the second aperture is sized to receive the securing pin along the second receiving axis so the securing pin is configured to engage the detenting switch to restrict movement of the detenting switch along the first receiving axis.

In some aspects, the techniques described herein relate to a reaction arm accessory, wherein the body includes a third aperture that is in communication with the first aperture and the splined connection, and wherein detenting pin is translatable supported within the third aperture.

In some aspects, the techniques described herein relate to a reaction arm accessory, wherein the detenting switch includes a circumferential groove, and wherein the circumferential groove is aligned with the second aperture such that the securing pin is received within the circumferential groove to secure the detenting switch within the first aperture.

In some aspects, the techniques described herein relate to a reaction arm accessory, wherein the cam surface of the detenting switch includes a convex portion and a concave portion that selectively engage with the detenting pin based on a rotational position of the detenting switch, when the detenting switch is in the unlocked position the detenting pin translates out of the splined connection and engages the concave portion, and when the detenting switch is in the locked position the detenting pin engages the concave portion to translate the detenting pin into the splined connection.

In some aspects, the techniques described herein relate to a reaction arm accessory, wherein the torsional spring includes a first end coupled to the detenting switch and a second end coupled to the body of the reaction arm accessory.

In some aspects, the techniques described herein relate to a reaction arm accessory, wherein the cam surface includes a first end and a second end that selectively engage with the detenting pin based on a rotational position of the detenting switch, the first end of the cam surface has a first radius and the second end of the cam surface has a second radius that is greater than the first radius, and the second end engages the detenting pin when the detenting switch is moved towards the locked position to translate the detenting pin is within the splined connection.

In some aspects, the techniques described herein relate to an extension configured to coupled to a splined connection of a reaction arm power tool, the extension including: a housing having a first end defining a mating splined connection and a second end defining a second splined connection; an output drive mechanism rotatably supported within the housing, the output drive mechanism configured to mesh with a drive output of the reaction arm power tool; and a quick-change removal assembly is coupled to the first end of the housing to selectively secure the mating splined to the splined connection of the reaction arm power tool, the quick-change removal assembly including a collar rotatably coupled to the housing, the collar having a plurality of detent regions and a cammed engagement surface defining a raised portion and a recessed portion, a detent locking ball configured to be engaged by the engagement surface of the collar to selectively move the detenting ball into communication with the mating splined connection through an aperture formed in the housing, and a biasing member positioned between the collar and the housing, the biasing member configured to selectively engage one of the detent regions to secure the collar in either a locked position or an unlocked position.

In some aspects, the techniques described herein relate to an extension, wherein the collar is configured to be rotated in either a clockwise or counterclockwise direction to move the collar from the locked position to a first unlocked position or a second unlocked position.

In some aspects, the techniques described herein relate to an extension, wherein the locked position, the first unlocked position, and the second unlocked position are separated by a predetermined angle, and wherein the raised portion of the cammed engagement surface is formed as a first arc that is less than the predetermined angle between the locked and unlocked position.

In some aspects, the techniques described herein relate to an attachment interface for a reaction arm tool, the attachment interface including: a housing having a first end configured to be coupled to the reaction arm tool and a second end opposite the first end, the housing defining a splined interface configured to selectively receive a reaction arm accessory having a splined connection; and a quick-change removal assembly coupled to the second end of the housing to selectively secure the splined connection of the reaction arm accessory to the attachment interface, the quick-change removal assembly including a plate rotatably supported on the second end of the attachment interface, the plate having an interface that corresponds with the first splined interface, and a securing structure supported on the second end of the attachment interface, the securing structure configured to support the plate on the second end of the attachment interface, wherein plate is rotatable between an unlocked position where the interface of the plate is aligned with the splined interface so the splined connection of the reaction arm accessory can be translated axially onto the splined interface and a locked position where the interface of the plate is misaligned with the splined interface to restrict axial movement of the reaction arm accessory.

In some aspects, the techniques described herein relate to an attachment interface, wherein the splined interface is a first splined interface, and wherein the interface defines a second splined interface that has an identical geometry as the first splined interface.

In some aspects, the techniques described herein relate to an attachment interface, further including a biasing member configured to selectively secure the plate in a locked position or an unlocked position.

In some aspects, the techniques described herein relate to an attachment interface, further including a detent locking ball that is urged by the biasing member into engagement with a recess formed on the plate to secure the plate in the locked position or the unlocked position.

In some aspects, the techniques described herein relate to an attachment interface, wherein the interface includes a plurality of teeth separated by a valley, the recess is a first recess positioned proximate the teeth, a second recess is positioned proximate the valley, and the plate is secured in the unlocked position when the detent locking ball engages the first recesses and the plate is secured in the locked position when the detent locking ball engages the second recess.

### BRIEF DESCRIPTION OF THE DRAWINGS

FIG. 1 is a side view of a power tool with a reaction arm according to an embodiment of the disclosure.

FIG. 2 is a perspective view of a reaction arm accessory, illustrating a quick-change removal assembly in a locked position.

FIG. 3 is an exploded perspective view of a portion of the reaction arm accessory of FIG. 2, illustrating the quick-change removal assembly removed from the reaction arm accessory.

FIG. 4 is a perspective view of a portion of the reaction arm accessory of FIG. 2, illustrating a quick-change removal assembly in an unlocked position.

FIG. 5 is a perspective view of the quick-change removal assembly of FIG. 2 in the locked position.

FIG. 6 is a perspective view of the quick-change removal assembly of FIG. 3 in the unlocked position.

FIG. 7 is an exploded perspective view of a reaction arm accessory including a quick-change assembly according to another embodiment of the disclosure.

FIG. 8 is a perspective view of a detenting switch of the quick-change removal assembly of FIG. 7.

FIG. 9 is a perspective view of the quick-change removal assembly of FIG. 7 illustrating the quick-change removal assembly in a locked position.

FIG. 10 is a perspective view of the quick-change removal assembly of FIG. 7 illustrating the quick-change removal assembly in an unlocked position.

FIG. 11 is a perspective view of a reaction arm accessory according to another embodiment of the disclosure.

FIG. 12 is a perspective view of a reaction arm accessory according to another embodiment of the disclosure.

FIG. 13 is a perspective view of a reaction arm accessory according to another embodiment of the disclosure.

FIG. 14 is a perspective view of a reaction arm accessory according to another embodiment of the disclosure.

FIG. 15 is a perspective view of an extension for a power tool including a quick-change assembly according to another embodiment of the disclosure.

FIG. 16 is a cross-sectional perspective view of an extension of FIG. 15.

FIG. 17 is an exploded perspective view of the extension of FIG. 15 illustrating the quick-change assembly.

FIG. 18 is a perspective view of a portion of the extension of FIG. 15 illustrating the quick-change assembly.

FIG. 19 is a perspective view a collar of the quick-change assembly.

FIG. 20 is a front view of the extension of FIG. 13 illustrating the quick-change assembly in a first unlocked position.

FIG. 21 is a front view of the extension of FIG. 13 illustrating the quick-change assembly in a locked position.

FIG. 22 is a front view of the extension of FIG. 13 illustrating the quick-change assembly in a second unlocked position.

FIG. 23 is an exploded perspective view of an attachment interface of a power tool having a quick-change removal assembly and a reaction arm accessory.

FIG. 24 is a cross-sectional perspective view of the attachment interface of FIG. 23, illustrating the quick-change removal assembly.

FIG. 25 is another cross-sectional perspective view of the attachment interface of FIG. 23, illustrating a detent locking ball of the quick-change removal assembly.

FIG. 26 is a rear perspective view of a plate of the quick-change removal assembly.

FIG. 27 is a front view of the attachment interface with the reaction arm accessory, illustrating the quick-change removal assembly in an unlocked position.

FIG. 28 is a front view of the attachment interface with the reaction arm accessory, illustrating the quick-change removal assembly in a locked position.

FIG. 29 is a perspective view of the attachment interface of the power tool of FIG. 1.

FIG. 30 is a perspective view of a reaction arm accessory according to another embodiment of the disclosure.

FIG. 31 is a cross-sectional view of a portion of the reaction arm accessory of FIG. 30, illustrating a quick-change removal assembly according to an embodiment of the disclosure.

FIG. 32 is another perspective view of the attachment interface of the power tool of FIG. 1.

FIG. 33 is a perspective view of a reaction arm accessory according to another embodiment of the disclosure.

FIG. 34 is a front view of the reaction arm accessory of FIG. 33, illustrating a quick-change removal assembly in a first position.

FIG. 35 another front view of the reaction arm accessory of FIG. 33, illustrating the quick-change removal assembly in a second position.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

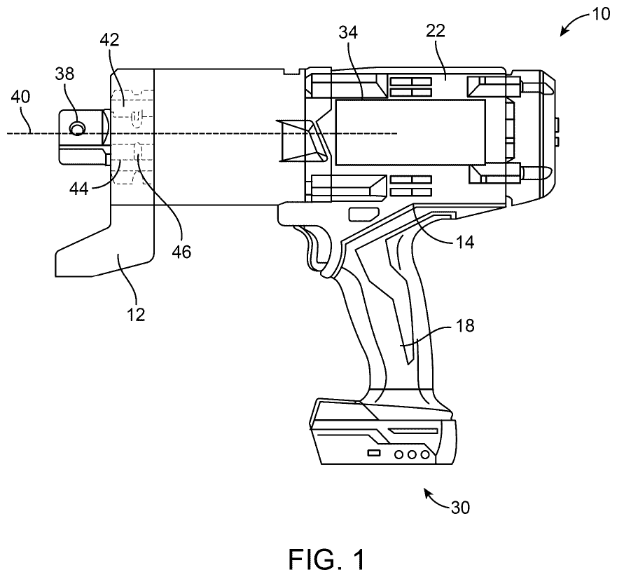

FIG. 1 illustrates a power tool 10 in the form of a reaction arm tool-a rotary direct drive power tool configured to apply torque to a workpiece (e.g., a fastener) and having a reaction arm 12 that may brace the tool against a fixed structure (e.g., an adjacent fastener, a wall, a clamp, etc.) to bear the reaction torque. As such, a user operating the power tool 10 does not experience the reaction torque on their hands and wrists allowing for higher torque outputs, repeatability, and reduced user fatigue.

The power tool 10 may be substantially similar to the power tool disclosed in International Publication No. PCT/US2023/027833, in the name of Milwaukee Electric Tool Corporation, the entire contents of which are incorporated herein by reference. As such, with reference to FIG. 1, the illustrated power tool 10 includes a housing 14 having a handle portion 18, a motor housing portion 22, and a battery receptacle 30 configured to receive a battery pack. In the illustrated embodiment, the battery receptacle 30 is located at a bottom end or foot of the handle portion 18 opposite the motor housing portion 22. A motor 34 is supported within the motor housing portion 22 and operably coupled to a drive assembly (e.g., such as a multi-stage planetary transmission). The motor 34 drives a drive assembly to provide an output torque at an output end or drive output 38 of the power tool 10. The drive assembly provides an output torque at an output end or drive output 38 of the power tool 10.

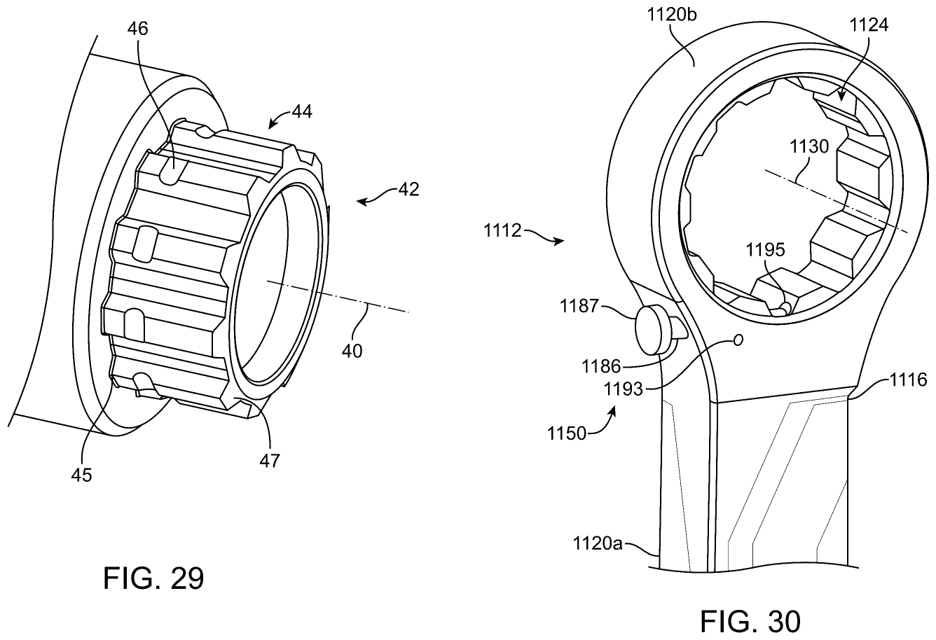

The tool 10 further includes an attachment interface 42 fixed to the housing and the drive output 38 extends from the housing 14 (e.g., through the attachment interface 42). The attachment interface 42 is non-rotatably coupled to the housing portion 22 and includes a splined interface 44 that meshes a corresponding splined connection of a reaction arm accessory, which is described in detail below. The attachment interface 42 further includes a plurality of circumferential recesses 46 formed in the splined interface 44. Best illustrated in FIG. 29, in the illustrated embodiment, the recesses 46 are formed in an outer surface of each external spline tooth of the splined interface 44 between a first or rear end 45 and a second or front end 47 of the splined interface 44. The recesses 46 are configured to receive a detenting pin, ball, or protrusion to selectively secure the reaction arm 12 to the tool 10, which is described in detail below.

The illustrated drive output 38 is configured as a square drive output with a generally square cross-section in a direction transverse to a drive axis 40. As such, the drive output 38 is configured for attachment to corresponding (i.e., square) drive tool bits, such as sockets (not shown). In other embodiments, the drive output 38 may have any other desired shape.

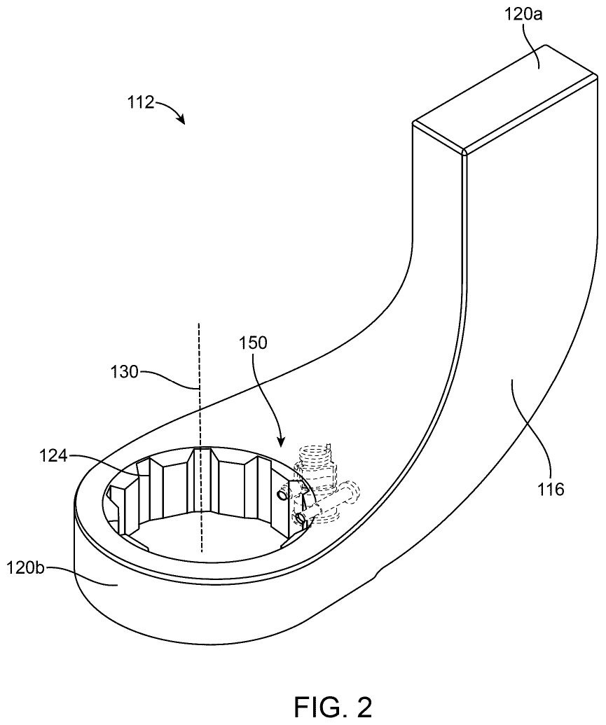

Now with reference to FIGS. 2-6, a reaction arm accessory 112 (e.g., a spline arm) according to an embodiment of the disclosure is illustrated. The reaction arm accessory 112 includes a body 116 having a distal end 120a or tip and an attachment end 120b. The attachment end 120b is configured to be coupled to the attachment interface 42 of the power tool 10, such that the body 116 extends away from the attachment interface 42 to the distal end 120a. The distal end 120a is configured to engage a fixed structure (e.g., an adjacent fastener in a bolt pattern) so the reaction arm accessory 112 transmits the reaction torque to the fixed structure rather than to a user holding the tool. The illustrated reaction arm accessory 112 further includes a splined connection 124 configured to engage with the splined interface 44 of the attachment interface 42 and a quick-change removal assembly 150 configured to selectively secure the reaction arm accessory 112 to the splined interface 44. The quick-change removal assembly 150 is rotatably supported in the body 116 adjacent the splined connection 124. An attachment axis 130 extends centrally through the splined connection 124 and is parallel with the drive axis 40 when the reaction arm accessory 112 is coupled to the tool 10.

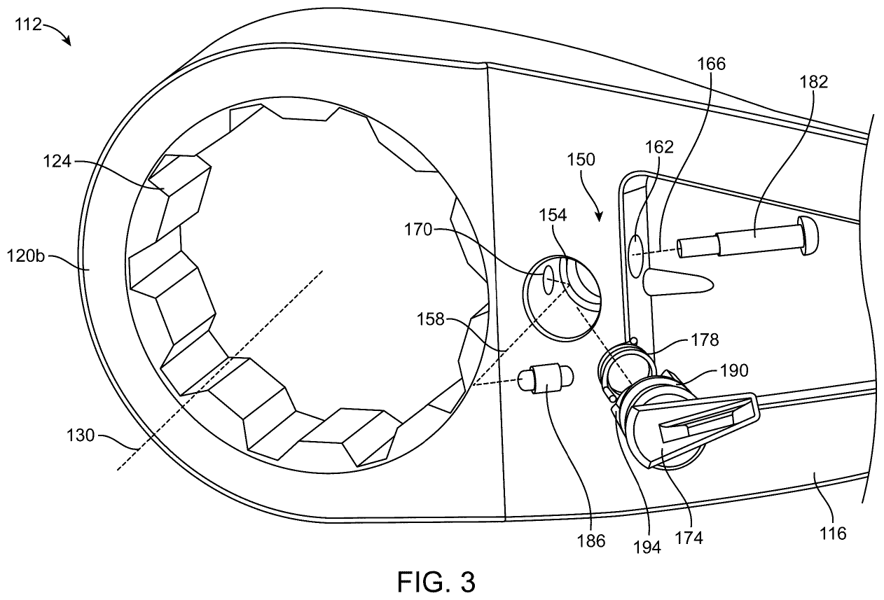

Now with reference to FIG. 3, the reaction arm accessory 112 includes a first bore 154 formed in the body 116 of the accessory 112. The first bore 154 defines a first receiving axis 158 that is parallel to the attachment axis 130 defined by the splined connection 124. A second bore 162 is formed in the body 116 such that the second bore 162 is in communication with the first bore 154. In the illustrated embodiment, the second bore 162 includes a first portion on a first side of the first bore 154 and a second portion on a second side of the first bore 154. In other words, the second bore 162 extends through the first bore 154. The second bore 162 defines a second receiving axis 166 that is orthogonal to the first receiving axis 158. A third bore 170 is defined in the body 116 such that the third bore 170 is in communication with the first bore 154 and the splined connection 124.

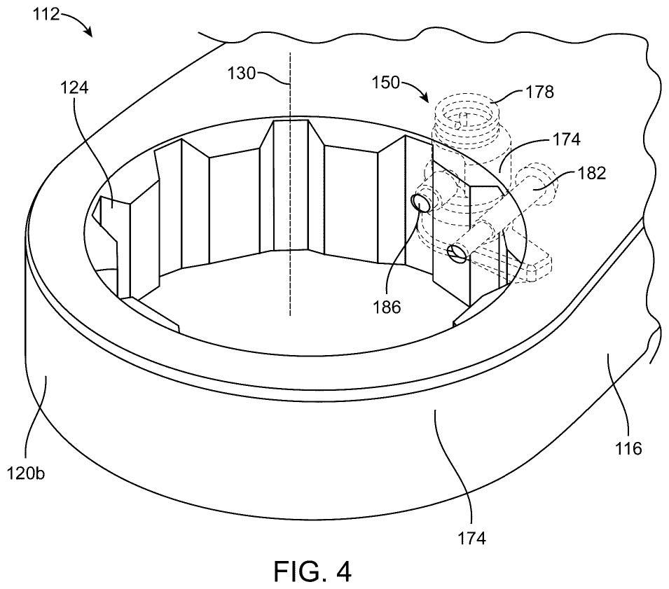

The quick-change removal assembly 150 includes a detenting switch 174 rotatably supported in the body 116, a torsional spring 178 configured to urge the detenting switch 174 towards a locked position, a securing pin 182 configured to secure the detenting switch 174 within the body 116, and a detenting pin 186 translationally supported within the body 116. The first bore 154 is sized to receive the detenting switch 174 and the torsional spring 178 along the first receiving axis 158. The second bore 162 is sized to receive the securing pin 182 along the second receiving axis 166 so the securing pin 182 is configured to engage the detenting switch 174. The third bore 170 receives the detenting pin 186. The detenting pin 186 is movable between an unlocked position where the detenting pin 186 is out of the splined connection 124 and a locked position where the detenting pin 186 extends within the splined connection 124. In the illustrated embodiment, the torsional spring 178 includes a first end 180a (FIG. 4) coupled to the detenting switch 174 and a second end 180b coupled to the body 116 of the reaction arm accessory 112. The torsional spring 178 urges the detenting switch 174 towards the locked position.

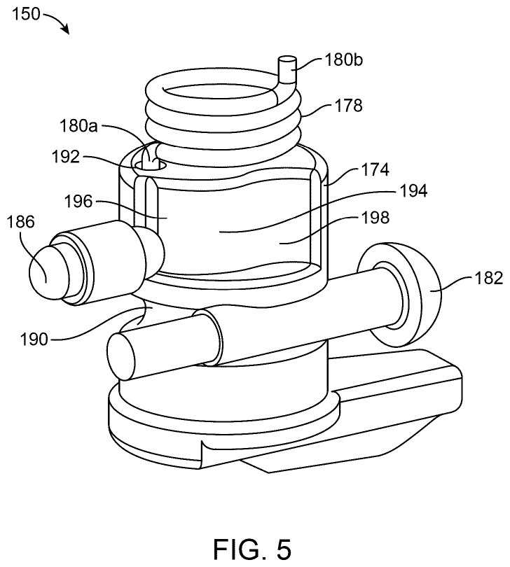

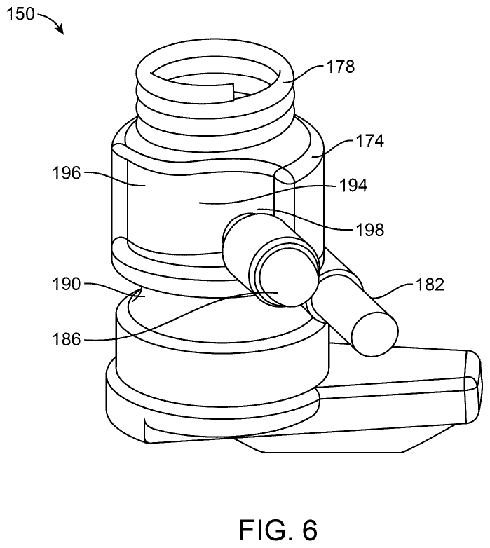

Now with reference to FIGS. 2, 4, 5 and 6, the quick-change removal assembly 150 is illustrated in the locked position (FIGS. 2 and 5) and the unlocked position (FIGS. 4 and 6). As shown in detail in FIGS. 5 and 6, the detenting switch 174 includes a circumferential groove 190, a cam surface 194, and a receiving aperture 192 configured to receive the first end 180a of the torsional spring 178. The circumferential groove 190 is sized to receive the securing pin 182 to restrict movement of the detenting switch 174 along the first receiving axis 158. The cam surface 194 includes a convex portion 196 and a concave portion 198 that selectively engage with the detenting pin 186 based on a rotational position of the detenting switch 274. The geometry of the cam surface 194 translates the detenting pin 186 within the third bore 170 to selectively move the detenting pin 186 within the splined connection 124 to secure the arm 54 to the attachment interface 42 (FIG. 1). In other words, the cam surface 194 of the detenting switch 174 is configured translate the detenting pin 186 between a first position where the detenting pin 186 is within the splined connection 124 when the detenting switch 174 is in the locked position (FIGS. 2 and 5) and a second position where the detenting pin 186 is out of the splined connection 124 when the detenting switch 174 is in the unlocked position (FIGS. 4 and 6). I

The orientation of the bores 154, 162, 170 allows the quick-change removal assembly 150 to be installed and removed from the body 116 of the reaction arm accessory 112. To assemble the quick-change removal assembly 50, the detenting pin 186 is inserted within the third bore 170. The torsional spring 178 and the detenting switch 174 are then inserted within the first bore 154 along the first receiving axis 158 such that the circumferential groove 190 is aligned with the second bore 162 and the cam surface 194 is aligned with the detenting pin 186 inserted within the third bore 170. The securing pin 182 is inserted within the second bore 162 along the second receiving axis 166 such that the securing pin 182 is received within the circumferential groove 190 to secure the detenting switch 174 within the first bore 154.

In order to install or remove the reaction arm accessory 112 from the tool 10, the user rotates the detenting switch 174 counterclockwise about the first receiving axis 158, which releases the detenting pin 186 out of the splined connection. In particular, the cam surface 194 is moved so the detenting pin 186 translates out of the splined connection and engages the concave portion 198. Once the reaction arm accessory 112 is installed, the detenting switch 174 is rotated clockwise by the force of the torsional spring 178. In particular, the convex portion 196 engages the detenting pin 186 to displace the detenting pin 186 within the splined connection 124 and in communication with the circumferential recesses 46 formed in the splined interface 44 of the tool 10, which secures the reaction arm accessory 112 to the attachment interface 42.

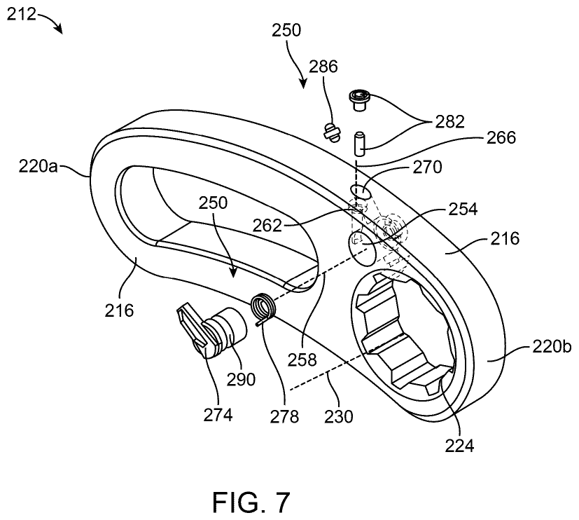

FIGS. 7-10 illustrate a reaction arm accessory 212 (e.g., a wheel lug arm) having a quick-change removal assembly 250 according to another embodiment of the disclosure. The reaction arm accessory 212 is similar to the reaction arm accessory 112 shown in FIG. 2-6 and described above. Therefore, like features are identified with like reference numerals plus “100”, and only the differences between the two will be discussed.

The reaction arm accessory 212 includes a body 216 having a distal end 220a and an attachment end 220b. The attachment end 220b is configured to be coupled to the attachment interface 42 of the power tool 10, such that the body 216 extends away from the attachment interface 42 to the distal end 220a in a generally kidney bean shape. The illustrated reaction arm accessory 212 further includes a splined connection 224 configured to engage with the splined interface 44 of the attachment interface 42 and a quick-change removal assembly 250 configured to selectively secure the reaction arm accessory 212 to the splined interface 44. An attachment axis 230 extends centrally through the splined connection 224 and is parallel with the drive axis 40 when the reaction arm accessory 212 is coupled to the tool 10.

Now with reference to FIG. 3, the reaction arm accessory 212 includes a first bore 254 formed in a side surface of the body 216 of the accessory 212. The first bore 254 defines a first receiving axis 258 that is parallel to the attachment axis 230 defined by the splined connection 224. A second bore 262 is formed in a top surface of the body 216 such that the second bore 262 is in communication with the first bore 254. The second bore 262 defines a second receiving axis 266 that is orthogonal to the first receiving axis 258. A third bore 270 is defined in the body 216 such that the third bore 270 is in communication with the first bore 254 and the splined connection 224.

The quick-change removal assembly 250 includes a detenting switch 274, a torsional spring 278, a securing pin 282, and a detenting pin 286. The first bore 254 is sized to receive the detenting switch 274 and the torsional spring 278 along the first receiving axis 258. The second bore 262 is sized to receive the securing pin 282 along the second receiving axis 266 so the securing pin 282 is configured to engage the detenting switch 274. The third bore 270 receives the detenting pin 286 and is movable between an unlocked position where the detenting pin 286 does not extend within the splined connection 224 and a locked position where the detenting pin 286 extends within the splined connection 224. In the illustrated embodiment, the torsional spring 278 includes a first end 280a coupled to the detenting switch 274 and a second end 280b coupled to the body 216 of the reaction arm accessory 212. The torsional spring 278 urges the detenting switch 274 towards the locked position.

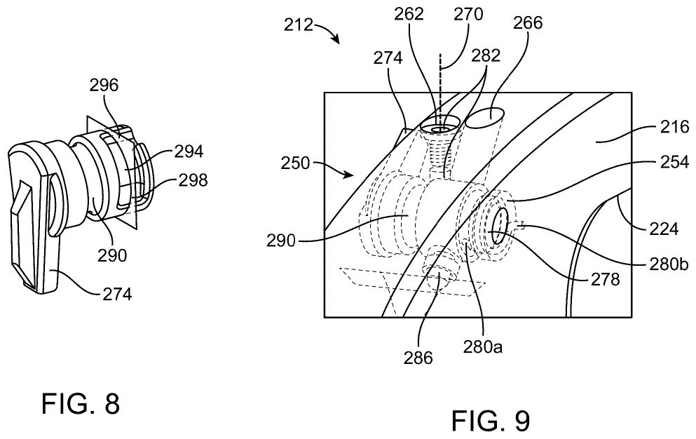

Now with reference to FIG. 8, the detenting switch 274 includes a circumferential groove 290, a cam surface 294, and a receiving aperture configured to receive the first end 280a of the torsional spring 278. The circumferential groove 290 is sized to receive the securing pin 282 to restrict movement of the detenting switch 274 along the first receiving axis 258. The cam surface 294 includes a first end 296 and a second end 298 that selectively engage with the detenting pin 286 based on a rotational position of the detenting switch 274. The geometry of the cam surface 294 allows the detenting pin 286 to selectively move within the splined connection 224 to secure the arm 54 to the attachment interface 42 (FIG. 1). For example, where the first end 296 of the cam surface 294 has a first radius and the second end 298 of the cam surface 294 has a second radius that is greater than the first radius. In other words, the second end 298 has a smaller clearance than the first end 296 such that the second end engages the detenting pin 286 when the detenting switch 274 is moved towards the locked position to translate the detenting pin 286 within the splined connection 224.

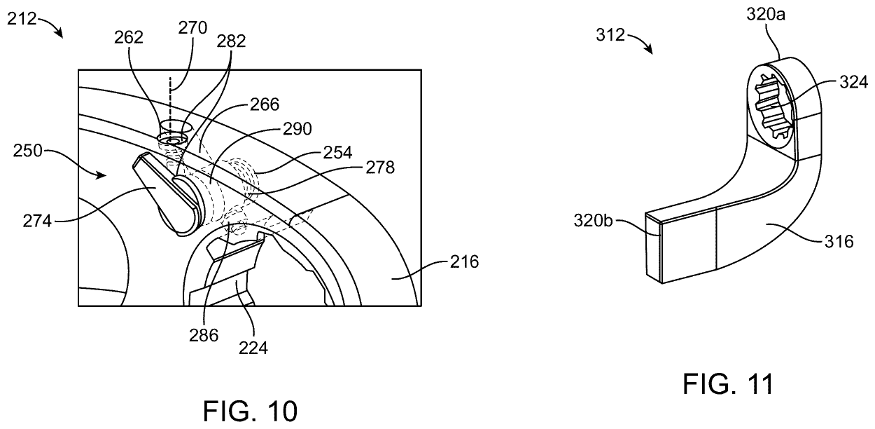

Now with reference to FIGS. 9 and 10, the quick-change removal assembly 250 is illustrated in the locked position (FIG. 9) and the unlocked position (FIG. 10). In order to install or remove the reaction arm accessory 212 from the tool 10, the user rotates the detenting switch 274 counterclockwise about the first receiving axis 258, which will release the detenting pin 286 by moving the cam surface 294 so the securing pin 182 engages the first end 296 of the cam surface 294. Once the reaction arm accessory 212 is installed, the detenting switch 274 is rotated clockwise by the force of the torsional spring 278. In particular, the second end 298 of the cam surface 294 engages the detenting pin 286 to displace the detenting pin 286 within the splined connection 224 and in communication with the circumferential recesses 46 formed in the splined interface 44 of the tool, which secures the reaction arm accessory 112 to the attachment interface 42.

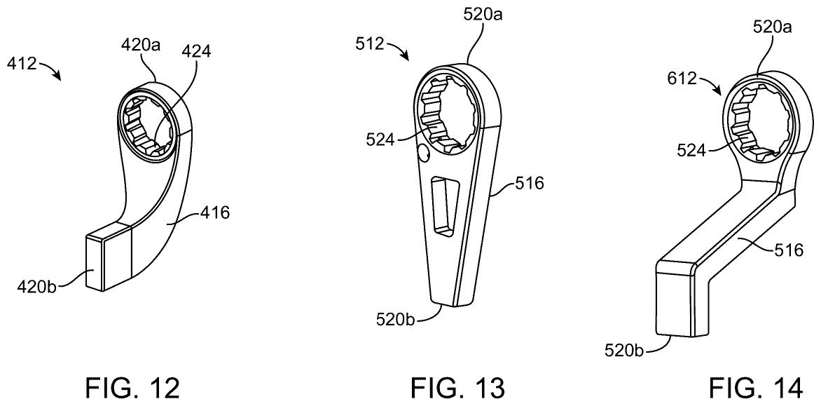

FIGS. 11-14 illustrate reaction arm accessories 312, 412, 512, 612 according to other embodiments of the disclosure. The reaction arm accessory 312, 412, 512, 612 have different geometries than the reaction arm accessories 112, 212 disclosed above, but are used in similar a similar fashion to reaction arm accessories 112 shown in FIG. 2-10 and described above. Therefore, like features are identified with like reference numerals plus “100”, and only the differences between the accessories will be discussed. It should also be appreciated that the quick-change removal assemblies 150, 250 may be used with any of the exemplary reaction arm accessories or other reaction arm accessories.

For example, the reaction arm accessory 312 is a small spline arm. The reaction arm accessory 412 is a large spline arm. The reaction arm accessory 512 is a deep well arm. The reaction arm accessory 612 is a straight arm. The reaction arm accessories 312, 412, 512, 612 may be coupled directly to the attachment interface 42 of the tool 10 or to an extension, which is described in more detail below.

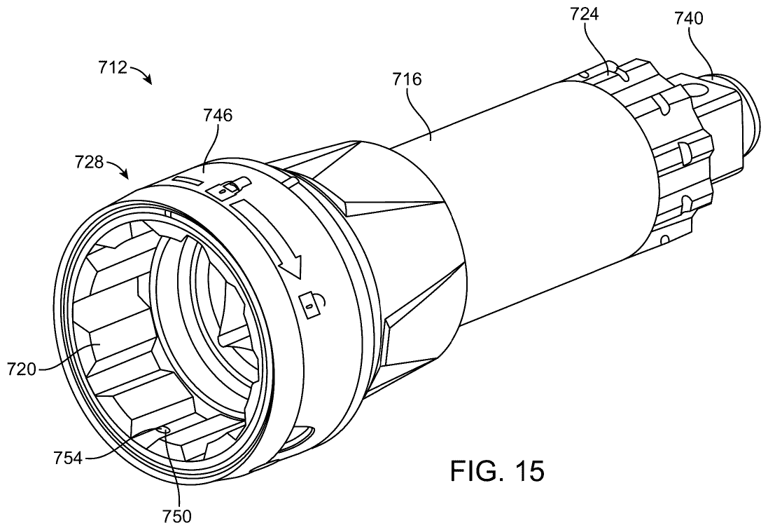

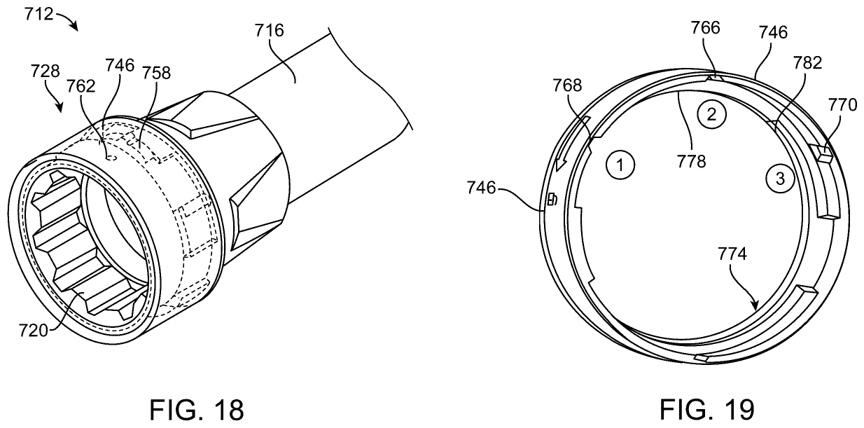

FIGS. 15-22 illustrate an extension 712 including a housing 716 having a first end defining a mating splined connection 720 and a second end defining a second splined connection 724. A quick-change removal assembly 728 is coupled to the first end of the housing 716 to selectively secure the mating splined connection 720 to the splined interface 44 of the tool 10.

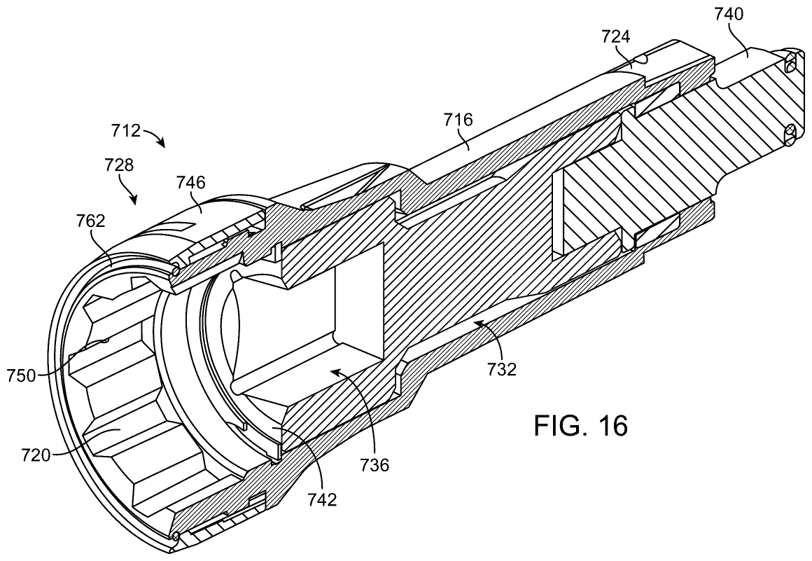

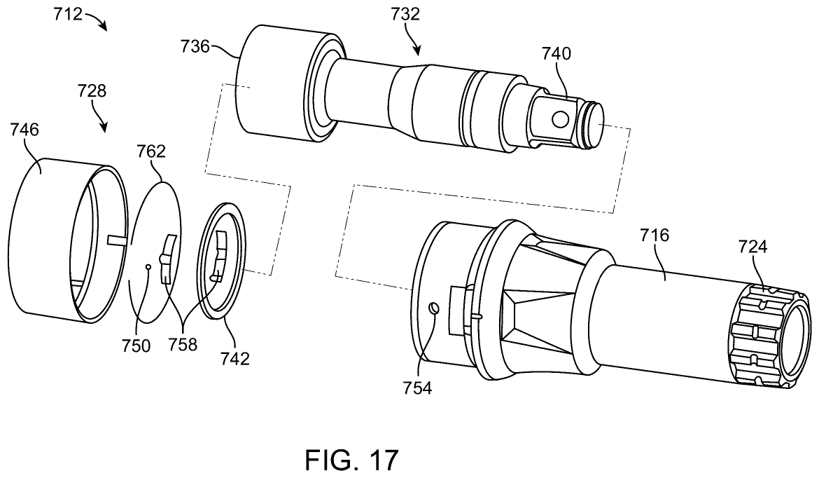

Now with reference to FIGS. 15-17, the extension 712 includes an output drive mechanism 732 (FIG. 16) that is rotatably supported within the housing 716 and is configured to mesh with the drive output 38 of the tool 10. The output drive mechanism 732 includes a socket 736 configured to be coupled to the drive output 38 of the tool and a second drive output 740. In the illustrated embodiment, the socket 736 has a generally square cross-section shape and the second drive output 740 also has a generally square cross-section shape. As such, the second drive output 740 is configured for attachment to corresponding (i.e., square) drive tool bits, such as sockets (not shown). In other embodiments, the second driver output may have any other desired shape. As shown in FIGS. 16 and 17, a securing member 742 (e.g., a retaining ring, a clamp, or the like) is coupled to the housing 716 and is configured to secure the drive mechanism 732 within the housing 716.

Now with reference to FIGS. 17-19, the quick-change removal assembly 728 includes a collar 746 rotatably coupled to the housing 716, a detent locking ball 750 that selective moves into communication with the mating splined connection 720 through an aperture 754 formed in the housing 716, a biasing member 758 positioned between the collar 746 and the housing 716, and a securing member 762 (e.g., a retaining ring, a clamp, or the like). An interior surface of the collar 746 includes a plurality of detent regions 766, 768, 770 (FIG. 19) configured to selectively receive the biasing member 758 to secure the collar 746 in either a locked position or an unlocked position and a cammed engagement surface 774 configured to engage the detent locking ball 750.

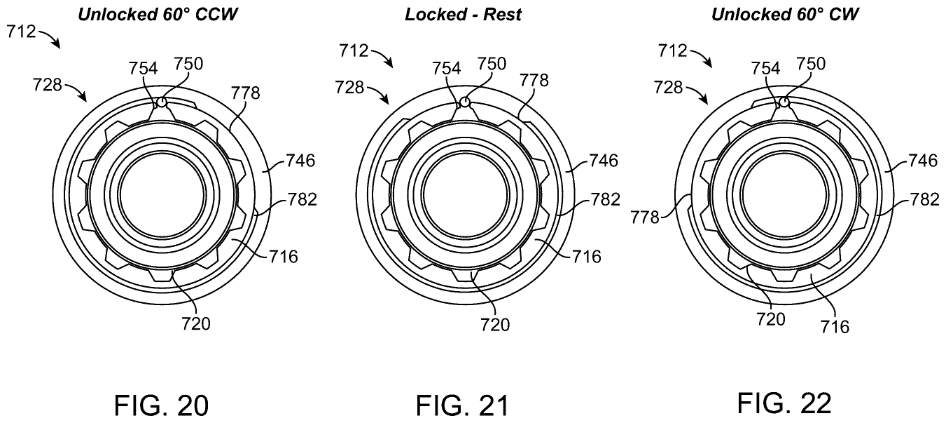

In the illustrated embodiment, the biasing member 758 is a leaf spring coupled to the housing 716. In other embodiments, alternative biasing members such as torsional springs, compression springs, or the like. The combination of the biasing member 758 and the detent regions 766, 768, 770 restricts the movement of the collar 746 to a predetermined range and provides distinct locked and unlocked positions for the collar 746. In particular, the locked and unlocked positions are separated by a predetermined angle. In the illustrated embodiment, the collar 746 has a range of motion of 120 degrees and the predetermined angle is 60 degrees between each position. In other embodiments the predetermined angle may be less than 60 degrees or greater than 60 degrees. For example, the collar 746 is configured to rotate either a clockwise direction from the locked position (FIG. 21) to a first unlocked position (FIG. 20) or a counterclockwise direction from the locked position to a second unlocked position (FIG. 22).

The cammed engagement surface 774 includes a first, raised portion 778 and a second, recessed portion 782. In the illustrated embodiment, the first raised portion 778 is formed as a first arc of the cammed engagement surface 774 and the second, recessed portion 782 is formed as a second arc of the cammed engagement surface 774. In other words, the first raised portion 778 of the cammed engagement surface 774 corresponds to the locked position of the collar 746 while the second, recessed portion 782 corresponds to the unlocked position of the collar 746. The first arc is less than the predetermined angle between the locked and unlocked position. In the illustrated embodiment, the first arc is less than 60 degrees of the circumference of the collar.

Now with reference to FIGS. 20-22, operation of the quick-change removal assembly 728 is illustrated. For example, FIG. 21 illustrates the collar 746 in the locked position, FIG. 20 illustrates the collar 746 in the first unlocked position and FIG. 22 illustrates the collar 746 in the second unlocked position (FIG. 22). In the locked position, the raised portion 778 of the engagement surface 774 engages the detent locking ball 750 to translate a portion of the detent locking ball 750 into the splined connection 720 and in communication with the circumferential recess 46 (FIG. 1) formed in the splined interface 44 of the tool 10, which secures the extension 712 to the attachment interface 42. Simultaneously, the biasing member 758 engages a first detent region 766 (FIG. 20) to secure the collar 746 in the locked position.

To remove the extension 712 from the tool 10, the collar 746 can be rotated in either a clockwise or counterclockwise direction to move the collar 746 from the locked position (FIG. 21) to the first unlocked position (FIG. 20) or the second unlocked position (FIG. 22). When the collar 746 is rotated in the clockwise direction towards the first unlocked position, the biasing member 758 compresses and moves out of engagement with the first detent region 766. Simultaneously, the detent locking ball 750 moves out of engagement with the raised portion 778 of the engagement surface 774 and engages the recessed portion 782, which allows the detent locking ball 750 to translate out of the splined connection 720. Once the collar 746 reaches the first unlocked position, the biasing member 758 engages a second detent region 768 (FIG. 19) to secure the collar 746 in the first unlocked position, which allows the extension 712 to be removed from the tool 10.

Additionally, or alternatively, when the collar 746 is rotated in the counterclockwise direction from the locked position (FIG. 21) towards the second unlocked position (FIG. 22), the biasing member 758 compresses and moves out of engagement with the first detent region 766. Simultaneously, the detent locking ball 750 moves out of engagement with the raised portion 778 of the engagement surface 774 and engages the recessed portion 782, which allows the detent locking ball 750 to translate out of the splined connection 720. Once the collar reaches the second unlocked position, the biasing member 758 engages a third detent region 770 (FIG. 19) to secure the collar 746 in the second unlocked position, which allows the extension 712 to be removed from the tool 10.

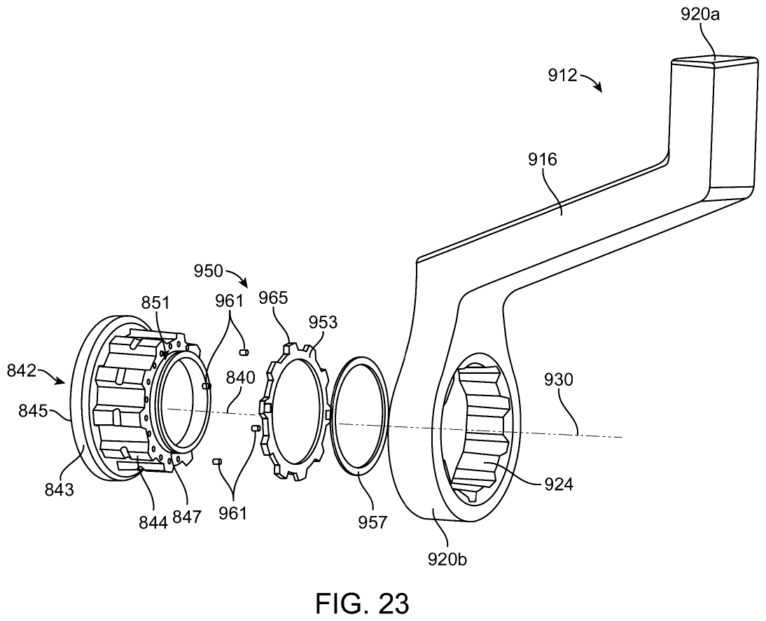

FIGS. 23-27 illustrate a reaction arm accessory 912 (e.g., a spline arm) configured to be coupled to an attachment interface 842 having a quick-change removal assembly 950 according to another embodiment of the disclosure. The reaction arm accessory 912 is similar to the reaction arm accessory 112 shown in FIG. 2-6 and the attachment interface 42 shown in FIG. 1 described above. In contrast to the reaction arm accessory 112, the quick-change removal assembly 950 is coupled to the attachment interface 842 instead of the reaction arm accessory 912. Therefore, like features are identified with like reference numerals plus “800”, and only the differences between the two will be discussed.

The reaction arm accessory 912 includes a body 916 having a distal end 920a or tip and an attachment end 920b. The attachment end 920b is configured to be coupled to the attachment interface 842 of the power tool, such that the body 916 extends away from the attachment interface 842 to the distal end 920a. The distal end 920a is configured to engage a fixed structure (e.g., an adjacent fastener in a bolt pattern) so the reaction arm accessory 912 transmits the reaction torque to the fixed structure rather than to a user holding the tool. The illustrated reaction arm accessory 912 further includes a splined connection 924 configured to engage with a first splined interface 844 of the attachment interface 842. An attachment axis 930 extends centrally through the splined connection 924 and is parallel with a drive axis 840 of the attachment interface 842 when the reaction arm accessory 912 is coupled to the tool.

The attachment interface 842 includes a housing 843 having a first end 845 coupled to the tool and a second end 847 opposite the first end 845. The first splined interface 844 extends at least partially between the first end 845 and the second end 847. The second end 847 defines a recess 851 configured to receive the quick-change removal assembly 950, which is configured to selectively secure the reaction arm accessory 912 to the first splined interface 844. The quick-change removal assembly 150 includes a plate 953 rotatably supported on the second end 847 of the attachment interface 844, a securing structure 957 (e.g., spiral ring) supported on the second end 847 of the attachment interface 844, and one or more biasing members 961 that selectively secure the plate 953 in a locked position or an unlocked position. In the illustrated embodiment, the plate 953 and the securing structure 957 are supported within the recess 851 of the second end 847 housing 843. The biasing member(s) 961 includes four compression springs that are circumferential spaced on the second end 847 of the attachment interface. In other embodiments, the biasing member(s) may include more compression spring (e.g., five, six, etc.) or less compression springs (e.g., three, two, one).

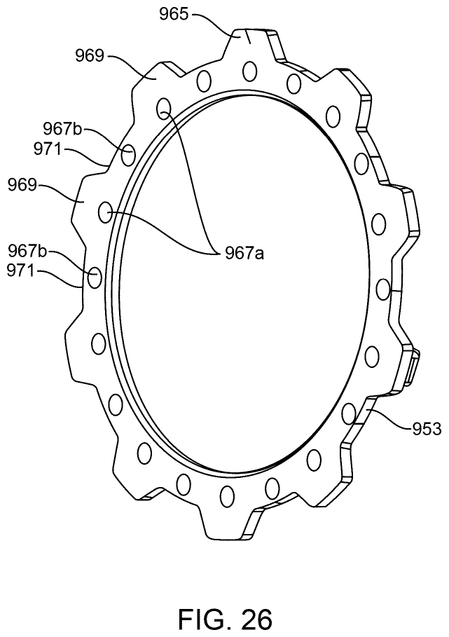

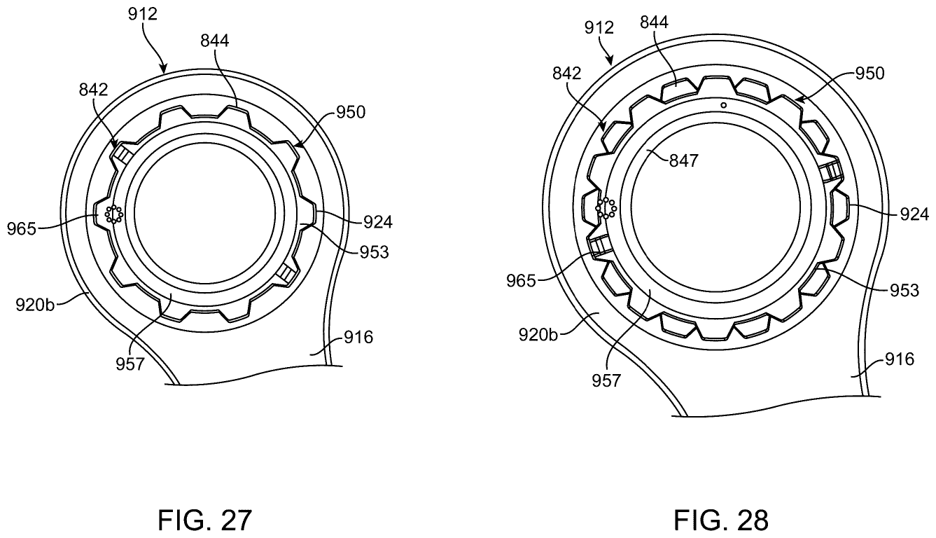

Now with reference to FIGS. 25 and 26, the plate 953 includes an interface 965 that corresponds with the first splined interface 844. The interface is rotatable between an unlocked position (FIG. 27) and a locked position (FIG. 28). In the illustrated embodiment, the interface 965 defines a second splined interface that has an identical geometry as the splined interface 844. In particular, the interface 965 includes a plurality of teeth 969 (FIG. 26) separated by valleys 971 (FIG. 26). In other embodiments, the plate 953 may have an alternative geometry than the splined interface 844. For example, the interface 965 may have any geometry that does not enter the splined interface 844 when the plate 953 is positioned in the unlocked position (FIG. 26).

The quick-change removal assembly 950 further includes a detent locking ball 963 (FIG. 25) that is urged by the biasing member 961 (FIG. 25) into engagement with a recess 967a, 967b formed on the plate 953. In the illustrated embodiment, the plate 953 includes a first set of recesses 967a circumferentially spaced around the plate 953 at a position corresponding to the teeth 969 (e.g., proximate the teeth 969) and a second set of recesses 967b circumferentially spaced around the plate 953 at a position corresponding to the valleys 971 of the plate 953 (e.g., proximate the valley 971). The detent locking ball 963 selectively engages one of the recesses 967a, 967b to secure the collar in either the unlocked position (FIG. 27) or the locked position (FIG. 28). For example, when the detent locking ball 963 engages one of the first set of recesses 967a, the plate 953 is secured in the unlocked position and when the when the detent locking ball 963 engages one of the second set of recesses 967b, the plate 953 is secured in the locked position.

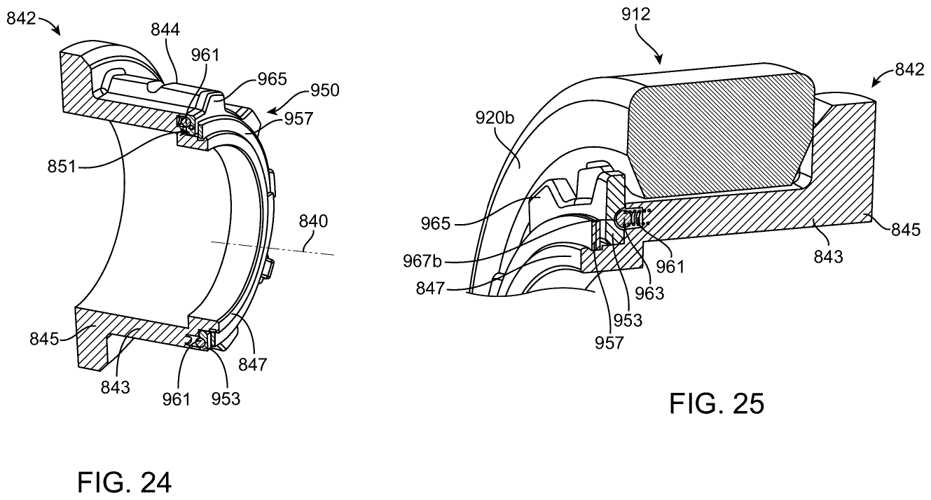

Now with reference to FIGS. 27 and 28, movement of the quick-change removal assembly 950 between the locked and unlocked position is illustrated. In the unlocked position, the interface 965 is aligned with the splined interface 844 of the attachment interface 842 so the splined connection 924 of the reaction arm accessory 912 can be translated axially along the drive axis 840 (FIG. 24). Simultaneously, the detent locking ball 963 (FIG. 25) engages one of the first set of recesses 967a to secure the plate 953 the unlocked position. Once the reaction arm accessory 912 is coupled to the attachment interface 842, the plate 953 is rotated towards the locked position (FIG. 26) where the interface 965 is misaligned with the first splined interface 844. As the plate 953 is rotated the detent locking ball 963 moves out of engagement with the recesses 967a and engages with one of the second set of recesses 967b to secure the plate 953 in the locked position. Misaligning the interface 965 from the first splined interface 844 restricts axial movement of the reaction arm accessory 912 along the drive axis 840, which secures the reaction arm accessory 912 to the attachment interface 842. To remove the reaction arm accessory 912 from the attachment interface 842, the plate 953 is rotated towards the unlocked position (FIG. 25) where the interface 965 is aligned with the first splined interface 844. The reaction arm accessory 912 can then be translated along the drive axis 840 to remove the reaction arm accessory from the attachment interface 842.

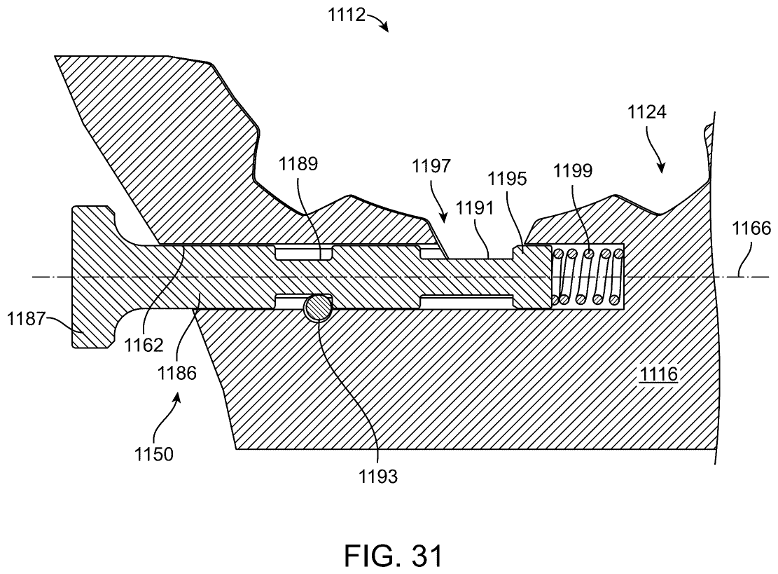

FIGS. 30-31 illustrate a reaction arm accessory 1112 (e.g., a spline arm) according to another embodiment of the disclosure. The reaction arm accessory 1112 is similar to the reaction arm accessory 112 shown in FIG. 2-6 and described above. Therefore, like features are identified with like reference numerals plus “1000”, and only the differences between the two will be discussed.

The reaction arm accessory 1112 includes a body 1116 having a distal end 1120a and an attachment end 1120b. The attachment end 1120b is configured to be coupled to the attachment interface 42 (FIG. 29) of the power tool 10. The illustrated reaction arm accessory 1112 further includes a splined connection 1124 (e.g., a ring with internal splines) configured to engage with the splined interface 44 of the attachment interface 42 (FIG. 29) and a quick-change removal assembly 1150 configured to selectively axially secure the reaction arm accessory 1112 to the splined interface 44 of the tool 10. An attachment axis 1130 extends centrally through the splined connection 1124. The attachment axis 1130 may be coaxial with the drive axis 40 when the reaction arm accessory 1112 is coupled to the tool 10.

Now with reference to FIG. 31, the reaction arm accessory 1112 includes a bore 1162 formed in a side surface of the body 1116 of the accessory 1112. The bore 1162 defines an axis 1166, which, in the illustrated embodiment, is orthogonal to the attachment axis 1130 and tangential to the splined connection 1124. A pin 1186 is received within the bore 1162. The pin 1186 includes a head 1187 having a larger diameter than a remainder of the pin 1186. The pin 1186 also includes a first groove 1189 and a second groove 1191 spaced apart along the axis 1166. A retaining pin 1193 extends through the body 1116 of the accessory 1112 parallel to the attachment axis 1130 and orthogonal to the axis 1166. The retaining pin 1193 extends through the first groove 1189 such that the ends of the first groove 1189 are respectively engageable with the retaining pin 1193 to limit translational movement of the pin 1186 along the axis 1166.

With continued reference to FIG. 31, the pin 1186 includes a shoulder 1195 defining an end of the second groove 1191 furthest from the head 1187. When the pin 1186 is in a locked position, as shown in FIG. 31, the shoulder 1195 extends into a gap 1197 defined between two adjacent teeth of the splined connection 1124. The pin 1186 is movable along the axis 1166 in an unlocking direction (to the right in FIG. 31) to an unlocked position (not shown), in which the shoulder 1195 is received within the bore 1162 such that the shoulder 1195 does not project into the gap 1197. The pin 1186 is biased towards the locked position by a spring 1199 (e.g., a coil spring) positioned between the pin 1186 and an end of the bore 1162.

In use, to attach the reaction arm accessory 1112 to the power tool 10, a user may push on the head 1187 of the pin 1186 to move the pin 1186 to the unlocked position against the force of the spring 1199. With the pin 1186 in the unlocked position, the splined connection 1124 can be positioned over the splined interface 44 of the tool 10 until the pin 1186 is generally aligned with the circumferential recesses 46 in a direction along the axes 40, 1130. The user may then release the pin 1186. When the pin 1186 is released, the pin 1186 moves to the locked position shown in FIG. 31 under the influence of the spring 1199. In the locked position, the shoulder 1195 extends into the gap 1197 and into one of the plurality of circumferential recesses 46. Engagement between the shoulder 1195 and the sidewall of the recess 46 axially retains the reaction arm accessory 1112 in place on the power tool 10. To remove the reaction arm accessory 1112, the user depresses the head 1187 of the pin 1186 to retract the shoulder 1195 from the recess 46 and out of the gap 1197.

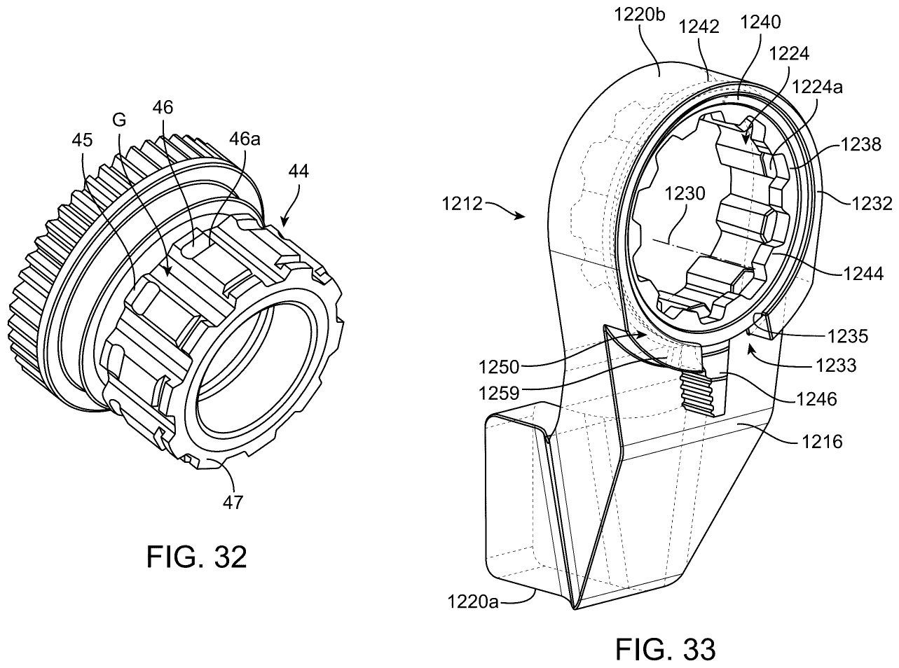

FIGS. 32-35 illustrate a reaction arm accessory 1212 (e.g., a spline arm) according to another embodiment of the disclosure. The reaction arm accessory 1212 is similar to the reaction arm accessory 112 shown in FIG. 2-6 and described above. Therefore, like features are identified with like reference numerals plus “1100”, and only the differences between the two will be discussed.

The reaction arm accessory 1212 includes a body 1216 having a distal end 1220a and an attachment end 1220b. The attachment end 1220b is configured to be coupled to the attachment interface 42 (FIGS. 29 and 32) of the power tool 10. In some embodiments, the body 1216 may include a central rib or spine with a greater thickness than a remainder of the body 1216 to increase the stiffness of the body 1216.

The illustrated reaction arm accessory 1212 further includes a splined connection 1224 (e.g., a ring with internal splines) configured to engage with the splined interface 44 of the attachment interface 42 (FIGS. 29 and 32) and a quick-change removal assembly 1250 configured to selectively axially secure the reaction arm accessory 1212 to the splined interface 44 of the tool 10. An attachment axis 1230 extends centrally through the splined connection 1224. The attachment axis 1230 may be coaxial with the drive axis 40 when the reaction arm accessory 1212 is coupled to the tool 10. The reaction arm accessory 1212 includes a lip 1232 extending from the attachment end 1220b in a direction parallel to the axis 1230 and surrounding the splined connection 1224. The lip 1232 is generally circular but includes a gap, or slot, 1233 interrupting the continuity of the lip 1232.

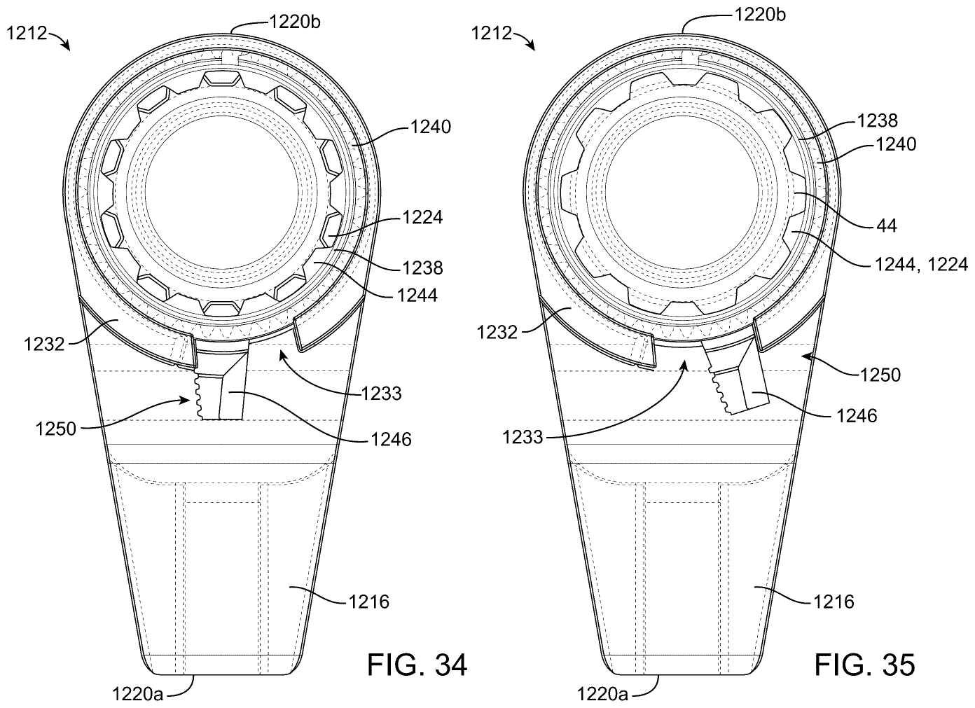

With reference to FIGS. 33-35, the quick-change removal assembly 1250 includes a locking collar 1238 positioned on the reaction arm accessory 1212, a ring 1240, and a spring 1242 (FIG. 33). The illustrated locking collar 1238 forms a closed ring shape and includes a plurality of locking protrusions 1244 formed annularly around an inner circumference of the locking collar 1238. The locking protrusions 1244 are trapezoidal shaped in the illustrated embodiment, but may have other shapes in other embodiments. An actuator 1246 extends radially outwardly from an outer circumference of the locking collar 1238 and is configured to move within the slot 1233 of the lip 1232 between an unlocked position (FIG. 35) and a locked position (FIG. 34). In the illustrated embodiment, the actuator 1246 abuts a first end of the slot 1233 when the locking collar 1238 is in the locked position, and the actuator 1246 abuts a second, opposite end of the slot 1233 when the locking collar 1238 is in the unlocked position. In the illustrated embodiment, the actuator 1246 includes a textured surface (e.g., ridges) to facilitate manipulation of the actuator 1246.

With reference to FIG. 33, the ring 1240 may be a snap ring, washer, or the like and is shaped and sized to fit within a circumferential groove 1235 formed on an inner side of the lip 1232. The illustrated ring 1240 has an inner diameter that is smaller than an outer diameter of the locking collar 1238. As such, the ring 1240 axially retains the locking collar 1238 while allowing rotational movement of the locking collar 1238 relative to the reaction arm accessory 1212. In the illustrated embodiment, the ring 1240 is concentric with the locking collar 1238. In some embodiments, the ring 1240 may abut a front face of the locking collar 1238 to axially retain the locking collar 1238. In other embodiments, one or more intermediate components (e.g., a low-friction washer) may be positioned between the ring 1240 and the locking collar 1238.

With continued reference to FIG. 33, the illustrated spring 1242 is a torsion spring that biases the locking collar 1238 toward the locked position. Specifically, the spring 1242 applies a force that urges the locking protrusions 1244 into engagement with the recesses 46 of the attachment interface 42. The spring 1242 forms a ring shape in the illustrated embodiment and surrounds the locking collar 1238. The illustrated spring 1242 includes a first arm 1259 received in a correspondingly-shaped recess formed in the lip 1232 to fix the first arm 1259 to the body 1216 of the reaction arm accessory 1212. A second arm (not shown) of the spring 1242 is coupled to the locking collar 1238. For example, the second arm may be received in a slot formed in the actuator 1246. The second arm separates from the first arm 1259 when the locking collar 1238 is moved toward the unlocked position, deforming the spring 1242 so that the spring 1242 provides a torsional biasing force tending to return the locking collar 1238 to the locked position. In other embodiments, other spring types and geometries may be used to bias the locking collar 1238 toward the locking position.

In operation, when the actuator 1246 is in the unlocked position (FIG. 35), the protrusions 1244 are aligned with gaps G (FIG. 32) between adjacent splines of the splined interface 44, thereby allowing the reaction arm accessory 1212 to slide along the attachment interface 42 for attachment to the power tool 10. Once the reaction arm accessory 1212 is positioned on the attachment interface 42, the actuator 1246 of the locking collar 1238 may be actuated (e.g., under the influence of the spring 1242) to move the locking collar 1238 from the unlocked position to the locked position. Specifically, the actuator 1246 moves along the slot 1233 in a first rotational direction (e.g., clockwise).

In the locked position (FIG. 34), each of the locking protrusions 1244 rotates into a corresponding recess 46 on the splined interface 44. Engagement between the locking protrusions 1244 and front walls 46a of the recesses 46 axially secures the reaction arm accessory 1212 in place, inhibiting removal from the power tool 10. In other embodiments, the locking protrusions 1244 may instead engage against the rear end 45 of the splined interface 44 (i.e., the rear ends of the spline teeth of the splined interface 44) when in the locked position. The spring 1242 continuously biases the locking collar 1238 toward the locked position, ensuring that the locking collar 1238 remains engaged during use.

To remove the reaction arm accessory 1212, the actuator 1246 is rotated in a second rotational direction (e.g., counterclockwise) against the biasing force of the spring 1242, repositioning the locking protrusions 1244 into alignment with the spline teeth 1224a of the splined connection 1224 (and thus, into alignment with the gaps G between the spline teeth of the splined interface 44 of the power tool 10). This allows the reaction arm accessory 1212 to be slid off the attachment interface 42 in a direction along the attachment axis 1230.

Although the disclosure has been described in detail with reference to certain preferred embodiments, variations and modifications exist within the scope and spirit of one or more independent aspects of the disclosure as described.

Various features and aspects of the present disclosure are set forth in the following claims.

What is claimed is:

1. A reaction arm accessory for a power tool, the reaction arm accessory comprising:
a body having a distal end configured to engage a fixed structure and an attachment end defining a splined connection configured to engage a splined interface of the power tool, the splined interface including a plurality of spline teeth defining gaps between adjacent spline teeth; and
a quick-change removal assembly supported in the body adjacent the splined connection and configured to selectively secure the reaction arm accessory to the splined interface of the tool, the quick-change removal assembly including
a collar rotatable between a locked position and an unlocked position, the collar including a plurality of locking protrusions, and
a spring surrounding the collar and configured to urge the collar towards the locked position,
wherein each of the plurality of locking protrusions is configured to engage a corresponding one of the plurality of spline teeth when the collar is in the locked position to axially retain the reaction arm accessory on the power tool, and
wherein each of the plurality of locking protrusions is aligned with a respective one of the gaps when the collar is in the unlocked position to allow the reaction arm accessory to be axially removed from the power tool.

2. The reaction arm accessory of claim 1, wherein each of the plurality of locking protrusions has a trapezoidal shape.

3. The reaction arm accessory of claim 1, wherein the spring is a torsion spring.

4. The reaction arm accessory of claim 1, wherein the spring includes a first arm coupled to the body and a second arm coupled to the collar.

5. The reaction arm accessory of claim 1, wherein the attachment end of the body includes a lip surrounding the splined interface.

6. The reaction arm accessory of claim 5, wherein the collar includes an actuator extending radially outwardly from the collar.

7. The reaction arm accessory of claim 6, wherein the lip includes a slot, and wherein the actuator is received within the slot.

8. The reaction arm accessory of claim 7, wherein the actuator abuts a first end of the slot when the collar is in the locked position and abuts a second end of the slot opposite the first end when the collar is in the unlocked position.

9. The reaction arm accessory of claim 6, wherein the actuator includes a textured surface to facilitate manipulation of the actuator.

10. The reaction arm accessory of claim 5, further comprising a ring received within a circumferential groove formed on an inner side of the lip.

11. The reaction arm accessory of claim 10, wherein the collar defines an outer diameter, and wherein the ring defines an inner diameter smaller than the outer diameter such that the ring axially retains the collar while allowing rotational movement of the collar.

12. The reaction arm accessory of claim 10, wherein the ring is concentric with the collar.

13. A reaction arm accessory for a power tool, the reaction arm accessory comprising:
a body having a distal end configured to engage a fixed structure and an attachment end configured to receive and engage an attachment interface of the power tool such that the body is rotationally fixed relative to the attachment interface of the power tool; and
a quick-change removal assembly configured to selectively axially secure the body to the attachment interface of the tool, the quick-change removal assembly including
a collar rotatable between a locked position and an unlocked position, the collar including a locking protrusion configured to engage a portion of the attachment interface to prevent removal of the reaction arm accessory from the power tool along an axis when the collar is in the locked position, and wherein the locking protrusion is configured to move out of engagement with the portion of the attachment interface when the collar is moved to the unlocked position to permit removal of the reaction arm accessory from the power tool along the axis,
an actuator extending radially outwardly from the collar, and
a torsion spring surrounding the collar and configured to urge the collar towards the locked position.

14. The reaction arm accessory of claim 13, the locking protrusion has a trapezoidal shape.

15. The reaction arm accessory of claim 13, wherein the spring includes a first arm coupled to the body and a second arm coupled to the collar.

16. The reaction arm accessory of claim 13, wherein the actuator includes a textured surface to facilitate manipulation of the actuator.

17. The reaction arm accessory of claim 13, further comprising a ring, wherein the collar defines an outer diameter, and wherein the ring defines an inner diameter smaller than the outer diameter such that the ring axially retains the collar while allowing rotational movement of the collar.

18. The reaction arm accessory of claim 17, wherein the ring is concentric with the collar.

19. A reaction arm accessory for a power tool, the reaction arm accessory comprising:
a body having a distal end configured to engage a fixed structure and an attachment end defining a splined connection configured to engage a splined interface of the power tool; and
a quick-change removal assembly supported in the body adjacent the splined connection and configured to selectively secure the reaction arm accessory to the splined interface of the tool, the quick-change removal assembly including
a pin slidably supported in the body and movable between a locked position and an unlocked position, the pin having a shoulder, and
a spring configured to urge the pin towards the locked position,
wherein the shoulder is configured to engage a circumferential groove formed in the splined interface of the power tool when the pin is in the locked position to axially retain the reaction arm accessory on the power tool.

20. The reaction arm accessory of claim 19, wherein the reaction arm accessory is removable from the power tool along an axis when the pin is in the locked position, and wherein the pin is movable between the locked position and the unlocked position in a direction perpendicular to the axis.
